(19) United States
(12) Patent Application Publication
(10) Pub. No.: US 2009/0008218 A1
(43) Pub. Date: Jan. 8, 2009

(54) APPARATUS AND METHODS FOR ACCELERATING CONVEYED ARTICLES

(75) Inventor: Matthew L. Fourney, Laurel, MD (US)

Correspondence Address: LAITRAM, L.L.C.;LEGAL DEPARTMENT, 220 LAITRAM LANE, HARAHAN, LA, 70123, US

(73) Assignee: LAITRAM, L.L.C., Harahan, LA (US)

(21) Appl. No.: 11/773,258

(22) Filed: Jul. 3, 2007

(51) Int. Cl. B65G 47/22

(52) U.S. Cl. 198/412

(57) ABSTRACT

A belt conveyor and a method for accelerating articles conveyed atop a moving conveyor belt. The conveyor belt includes rollers that are arranged to rotate on axes transverse to the direction of belt travel. The rollers have a large-diameter portion on which conveyed articles ride and one or more smaller-diameter portions that can be engaged by a bearing surface to rotate the rollers as the conveyor belt advances in the direction of belt travel. Articles atop the large-diameter portion are propelled in the conveying direction at a speed greater than twice the forward speed of the belt.

### BACKGROUND

The invention relates to power-driven conveyors generally and, more particularly, to belt conveyors having article-supporting rollers selectively contacted by bearing surfaces to rotate the rollers as the belt advances.

Conveyor belts having article-supporting rollers that ride on stationary bearing surfaces to rotate the rollers as the belt advances are used to increase the spacing between consecutively conveyed articles. Cylindrical rollers rotating on axes perpendicular to the direction of belt travel propel articles forward atop the rollers at an absolute speed of twice the belt speed. One way to increase the speed of the rollers is to move the bearing surface contacting the rollers opposite to the direction of belt travel, such as by providing the bearing surface on a flat belt advancing under the conveyor belt in the opposite direction. This causes the rollers to propel articles forward at a speed equal to twice the magnitude of the differential velocity between the conveyor belt and the flat belt. But using a separate belt as a bearing surface requires a second drive mechanism, which makes a more complicated and expensive conveyor system.

### SUMMARY

This is overcome by a conveyor belt embodying features of the invention. The conveyor belt comprises rollers arranged to rotate on axles defining axes of rotation transverse to the direction of belt travel. Drive-receiving elements, such as chain links, on the belt receive the driving force that advances them along with the rollers in the direction of belt travel. The rollers include cylindrical first axial portions and second axial portions. The diameter of the second axial portions is less than the diameter of the first axial portions.

In another aspect of the invention, a conveyor comprises a conveyor belt having a plurality of rollers. A drive advances the conveyor belt in a direction of belt travel along a conveying path. The rollers are arranged to rotate on axes transverse to the direction of belt travel. The rollers have cylindrical first axial portions of a first diameter and second axial portions of a second diameter less than the first diameter. A bearing surface contacts the second portions along a first stretch of the conveying path. As the conveyor belt is driven along the conveying path, contact between the rollers and the bearing surface causes the rollers to rotate at a first speed.

In another aspect of the invention, a method for conveying articles comprises: (a) supporting articles atop the first axial portions of a series of rollers advancing at a first speed along a conveying path, wherein the first axial portions have a first diameter; (b) contacting second axial portions of the rollers with a bearing surface in a first stretch of the conveying path as the rollers advance, wherein the second axial portions have a second diameter less than the first diameter. In this way, the rollers rotate and propel the articles atop the first axial portions of the rollers along the first stretch of the conveying path at a second speed greater than twice the first speed.

### BRIEF DESCRIPTION OF THE DRAWINGS

These aspects and features of the invention, as well as its advantages are better understood by referring to the following description, appended claims, and accompanying drawings, in which:

FIG. 1 is an isometric view of a portion of a conveyor embodying features of the invention including accelerating rollers;

FIG. 2 is a cross section of the conveyor of FIG. 1 taken along lines 2-2 illustrating accelerating rollers with cylindrical axial portions of different diameters;

FIG. 3 is an isometric view of another version of an accelerating roller embodying features of the invention including an attachable narrow-diameter roller portion usable in a conveyor as in FIG. 1; and

FIG. 4 is a side elevation view of another version of an accelerating roller usable in a conveyor as in FIG. 1 and having a tapered axial portion.

### DETAILED DESCRIPTION

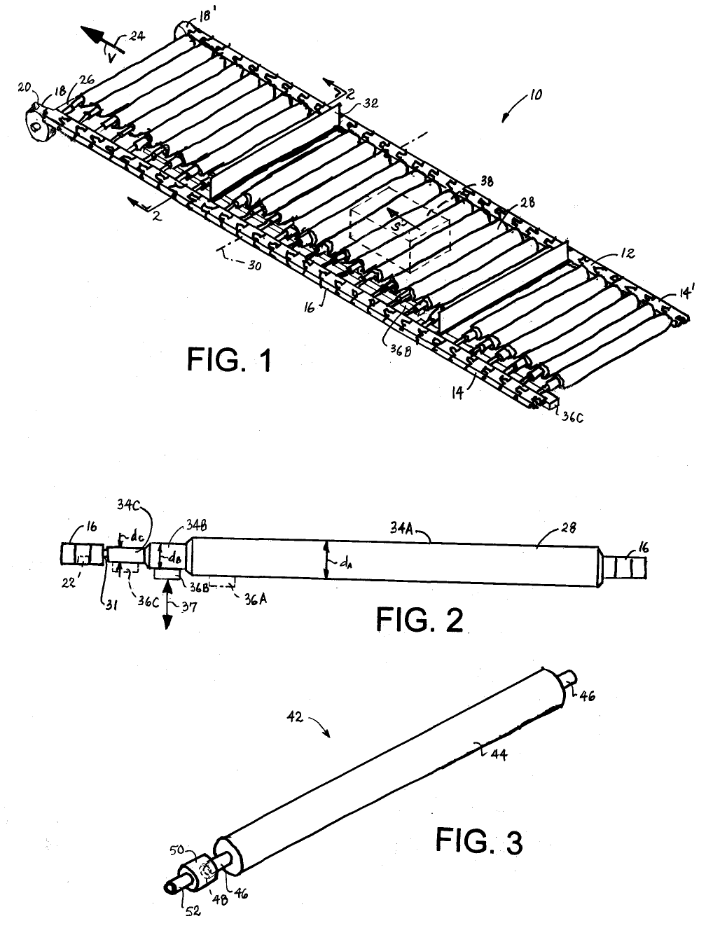

The top carryway portion of a conveyor embodying features of the invention is shown in FIG. 1. The conveyor 10 includes a conveyor belt 12 formed by a pair of parallel strands of roller chain 14, 14′ defining opposite sides of the conveyor belt. The roller chains are constructed of individual chain links 16 linked together end to end by hinge pins (not shown). The links serve as drive-receiving elements receiving a driving force from a drive element such as drive sprockets 18, 18′ at the downstream end of the conveyor carryway portion. Teeth 20 on the periphery of the drive sprockets engage recesses (22 in FIG. 2) in the undersides of the links to drive the links in a direction of belt travel 24 along a conveying path. The sprockets are mounted on a shaft 26, which is conventionally rotated by a drive comprising a motor in a gear box (not shown). The entire belt is supported conventionally in a conveyor frame (not shown).

A series of parallel rollers 28 span the space between the pair of rollers chains 14, 14′. The rollers are arranged to rotate on axes 30 transverse-in this example, perpendicular-to the direction of belt travel. Opposite ends (31 in FIG. 2) of the rollers serve as axles supported for rotation in the link chains at each side of the belt. Periodically spaced along the length of the conveyor belt are stops 32 supported at opposite ends in the link chains. The stops form barriers dividing the belt's conveying surface into successive bins.

As shown in FIG. 2, one version of the roller 28, has three axially offset cylindrical peripheral surfaces 34A, 34B, 34C each of a different diameter d_{A}, d_{B}, d_{C}, where d_{A}>d_{B}>d_{C}. The largest-diameter axial portion 34A is longer than the others and serves as the conveying surface for articles atop the belt. Each peripheral surface is externally contactable by a bearing surface 36A, 36B, or 36C, such as a wearstrip or other flat stationary or moving surface or even rollers. The bearing surface may be selectively moved into and out of contact with the rollers such as by being raised and lowered by pneumatic, hydraulic, electromagnetic, or other means as indicated by arrow 37.

In operation, no more than one of the bearing surfaces is in contact with the rollers at a given time. The forward motion of the conveyor belt over the bearing surface causes the rollers to rotate to accelerate conveyed articles 38 in the direction of belt travel. If, as shown in FIG. 2, the bearing surface 36B is in contact with the intermediate cylindrical portion 34B and the conveyor belt is advancing in the direction of belt travel at a linear speed v, the tangential speed s of the periphery of the large-diameter roller portion 34A is given by s=v (1+d_{A}/d_{B}) under a no-slip condition. Consequently, an article atop the belt is propelled forward by the rollers at a forward speed greater than twice the belt speed because d_{A}>d_{B}, until the article encounters a stop. If, instead, bearing surface 36C engages the narrowest-diameter portion 36C, an article atop the belt is propelled forward at an even greater speed s=v (1+d_{A}/d_{C}) because (d_{A}/d_{C})>(d_{A}/d_{B}). If, instead, the bearing surface 36A engages the large-diameter roller portion 34A directly, articles are propelled atop the rollers at a speed s=2 v.

As shown in FIG. 1, it is possible to rotate the rollers at different belt speeds along the length of the conveyor. With the first bearing surface 36C beneath the narrowest-diameter portion 34C of the rollers in a first upstream stretch 40 of the conveyor and a second bearing surface 36B beneath the intermediate-diameter portion 34B in a second downstream stretch 41, articles fed onto the belt can be propelled forward at a high speed initially and slowed to a lower speed as they approach a stop to avoid jolting impacts.

Another version of roller having only two externally contactable portions of different diameters is shown in FIG. 3. The roller 42 includes a standard roller 44 with axle stubs 46 extending outward from each end. One stub is inserted into a complementary recess 48 in a special smaller diameter portion 50 that includes an extending axle 52 received for support in a link chain. This represents a way of constructing a two-diameter roller using a standard roller that is simpler than the three-diameter roller of FIG. 2.

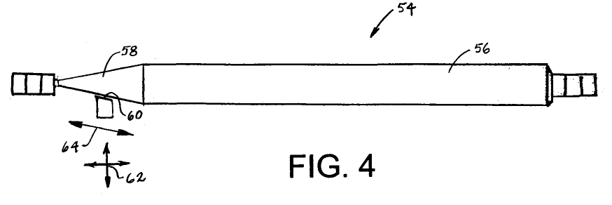

An accelerating roller with a conical, tapered axial portion is shown in FIG. 4. The roller 54 includes a cylindrical article-supporting axial portion 56 and a tapered axial portion 58. The tapered portion is contacted by a bearing surface 60 that is preferably tapered to match the taper of the tapered axial portion of the roller. The bearing surface is selectively engaged or disengaged from the roller by, for example, vertical or horizontal motion provided by electromagnetics, pneumatics, hydraulics, or the like, as indicated by arrows 62. The bearing surface is selectively movable along the taper as indicated by arrow 64 to contact the tapered portion at axial positions of different diameters to control the speed of the rollers. The linearly tapered peripheral surface enables continuous, as opposed to stepped, control of roller speed by selectively positioning the bearing surface along the tapered surface.

Although the invention has been described in detail with respect to a few preferred versions, other versions are possible. For example, the stops 32 are shown in FIG. 1 as upstanding flights, but other barriers or flat friction pads could be used to similar effect. As another example, the rollers could be mounted in a slat or other modular belt. So, as these few examples suggest, the scope of the invention is not meant to be limited to the versions described in detail.

What is claimed is:

1. A conveyor belt comprising:
drive-receiving elements for receiving a driving force to advance in a direction of belt travel;
a plurality of rollers advancing with the drive-receiving elements and having axles defining axes of rotation transverse to the direction of belt travel;
wherein the rollers further include cylindrical first axial portions having a first diameter and second axial portions having a second diameter less than the first diameter.

2. A conveyor belt as in claim 1 wherein the second axial portions are cylindrical with a constant second diameter.

3. A conveyor belt as in claim 1 wherein the second axial portions are tapered with a linearly varying second diameter.

4. A conveyor belt as in claim 1 comprising:
first and second series of parallel chain links defining first and second sides of the conveyor belt and including the drive-receiving elements;
wherein the plurality of axles are supported at the first and second sides of the conveyor belt by the first and second chain links.

5. A conveyor belt as in claim 4 wherein the axles extend outward from opposite ends of the rollers.

6. A conveyor belt as in claim 1 wherein the rollers include third axial portions having a third diameter less than the second diameter.

7. A conveyor belt as in claim 1 further comprising stops periodically spaced along the conveyor belt.

8. A conveyor comprising:
a conveyor belt including a plurality of rollers;
a drive advancing the conveyor belt in a direction of belt travel along a conveying path;
wherein the rollers are arranged to rotate on axes transverse to the direction of belt travel and include:
cylindrical first axial portions having a first diameter; and
second axial portions having a second diameter less than the first diameter;
a first bearing surface contacting the second axial portion along a first stretch of the conveying path to cause the rollers to rotate at a first speed as the conveyor belt is driven along the first stretch in the direction of belt travel.

9. A conveyor as in claim 8 wherein the second axial portions are cylindrical with a constant second diameter.

10. A conveyor as in claim 8 wherein the second axial portions are tapered with a linearly varying second diameter.

11. A conveyor as in claim 10 wherein the first bearing surface is selectively positionable axially along the second axial portions.

12. A conveyor as in claim 8 wherein the speed s of an article supported atop the first axial portion of the rollers in the first stretch of the conveying path is given by:
s=v(1+d_{A}/d_{B}),
where v is the speed of the conveyor belt in the direction of belt travel, d_{A} is the first diameter, and d_{B} is the second diameter.

13. A conveyor as in claim 8 wherein the rollers include third axial portions having a third diameter less than the second diameter, the conveyor further including a second bearing surface contacting the third axial portions along a second stretch of the conveying path to cause the rollers to rotate at a second speed greater than the first speed as the conveyor belt is driven along the second stretch in the direction of belt travel.

14. A conveyor as in claim 13 wherein the second stretch is upstream of the first stretch along the conveying path.

15. A conveyor as in claim 8 wherein the first bearing surface is selectively movable into and out of contact with the second axial portions of the rollers.

16. A conveyor as in claim 8 wherein the conveyor belt further includes stops periodically spaced along the conveyor belt at positions at which articles propelled in the first stretch of the conveying path atop the first portions of the rollers are stopped from advancing farther along the conveyor belt.

17. A method for conveying articles, comprising:
supporting articles atop first axial portions of a series of rollers advancing at a first speed along a conveying path, wherein the first axial portions of the rollers have a first diameter;
contacting second axial portions of the series of rollers with a bearing surface in a first stretch of the conveying path as the series of rollers advances along the conveying path, wherein the second axial portions have a second diameter less than the first diameter, to rotate the rollers and propel the articles atop the first axial portions of the rollers along the first stretch of the conveying path at a second speed greater than twice the first speed.

18. The method of claim 17 further comprising contacting third axial portions of the series of rollers with a bearing surface in a second stretch of the conveying path as the series of rollers advances along the conveying path, wherein the third axial portions have a third diameter less than the second diameter, to propel the articles atop the first axial portions of the rollers along the second stretch of the conveying path at a third speed greater than the second speed.

19. The method of claim 18 wherein the second stretch is upstream of the first stretch along the conveying path.
